(19) United States
(12) Patent Application Publication
(10) Pub. No.: US 2005/0076099 A1
(43) Pub. Date: Apr. 7, 2005

(54) Method and apparatus for live streaming media replication in a communication network

(75) Inventors: Phil Yonghui Wang, Nepean (CA); Franco Travostino, Arlington, MA (US); Tal Lavian, Sunnyvale, CA (US); Ramesh Durairaj, Santa Clara, CA (US)

Correspondence Address: JOHN C. GORECKI, ESQ., 180 HEMLOCK HILL ROAD, CARLISLE, MA, 01741, US

(73) Assignee: Nortel Networks Limited, St. Laurent (CA)

(21) Appl. No.: 10/745,869

(22) Filed: Dec. 26, 2003

Related U.S. Application Data
(60) Provisional application No. 60/508,680, filed on Oct. 3, 2003.

(51) Int. Cl. G06F 15/16

(52) U.S. Cl. 709/219

(57) ABSTRACT

Replication of live streaming media services (SMS) in a communication network may be enabled by introducing the streaming media-savvy replication service on a network element, through a number of functions such as client/service registration and classification, packet interception and forwarding, media replication, status monitoring and configuration management. In an embodiment, client requests and server replies of an SMS are intercepted and evaluated by the network element. If the SMS is not streaming through the network element, the replication service registers the SMS and establishes a unique SMS session for the requesting clients. If the SMS is already streaming through the network element, the replication service replicates the streaming media and forwards it to the requesting clients. This reduces bandwidth usage on the links connecting the streaming media server with the network element and reduces the number of client connections to the streaming media provider's servers.

### BACKGROUND OF THE INVENTION

1. Field of the Invention

The present invention relates to delivery of streaming media on a communication network and, more particularly, to a method and apparatus for live streaming media replication in a communication network.

2. Description of the Related Art

Data communication networks may include various computers, routers, switches, and other devices coupled to and configured to pass data to one another. These devices will be referred to herein as “network elements.” Data is communicated through the data communication network by passing protocol data units, such as frames, packets, cells, or segments, between the network elements by utilizing one or more communication links. A particular protocol data unit may be handled by multiple network elements and cross multiple communication links as it travels between its source and its destination over the network.

As communication networks have improved, it has become common to stream live media across the network from a media server to a requesting end user. FIG. 1 illustrates one example of a communication network that may be used to deliver a streaming media service (SMS) from an SMS provider having one or more streaming media server(s) 10 to an end user 12. As shown in FIG. 1, in this example, the streaming media server is connected either directly or via an intermediate network to a backbone network 14. The backbone network may have multiple network elements 16, such as routers and switches, configured to handle high bandwidth traffic.

At the edge of the backbone network, one or more edge network devices 18 take traffic off the backbone network and place it onto a metropolitan area network 20. The metropolitan area network is made up of sub-networks, referred to herein as edge networks 22. Each edge network may connect one or more end networks 24 configured to interface directly with end users 12.

Conventionally, as shown in FIG. 2, if an end user 12 desires to have access to a streaming media service (SMS), the end user 12 sends a request to a streaming media server 10. When resource is allowed, the streaming media server accepts the user request and transmits the streaming media service to the end user 12. An SMS session is created for each end user, as shown in FIG. 2, so that each end user could be provided with the streaming media.

Unfortunately, the bandwidth provided in the edge networks and end networks may not be sufficient to handle the streaming media, or may cause provision of such services to become prohibitively expensive. For example, it may take up to 5 Mbps of transmission capacity to stream full motion video media to an end user. If an end network 24 is serving 250 end users, the end network would be required to have purchased 1 Gbps of available bandwidth on the link 26. In addition to this, the network element 28 will also need to reserve bandwidth on the link 26 to fulfill its service level agreements with other end users that may require bandwidth other than in connection with the streaming media. Thus, although there may be plenty of bandwidth on the backbone network to handle streaming media traffic, the metropolitan area networks, edge networks, and end networks may not have purchased or installed sufficient bandwidth to provide streaming media to potential end users.

One attempt to overcome this issue is to transmit the packets using a multicast protocol. Multicast protocols operate at the link level or network level to cause network devices to replicate packets in a tree like structure. Unfortunately, to transport multicast traffic, the streaming media server, the end user, and all of the network devices in between must be multicast enabled and support the particular multicast protocol. Additionally, multicast protocols tend to be complicated, and much more difficult to implement reliably than the well established unicast protocols. Several multicast protocols will be discussed below.

Internet Protocol (IP) multicasting has been proposed for many years with a well-defined suite of protocols, such as Internet Group Multicast Protocol (IGMP), Distance Vector Multicast Routing Protocol (DVMRP), Multicast extended Open Shortest Path First (MOSPF), Protocol Independent Multicast (PIP)-Dense Mode (PIM-DM), PIM-Sparse Mode (PIM-SM), and PIM-Source Specific Multicast (PIM-SSM). IP multicasting is useful, in that it replicates content without redundancy throughout the network. However, IP multicasting has weak network security, unidentified members, complicated protocols, requires specific software and hardware implementations, and has experienced scalability problems in large networks.

Mbone (Multicast backBONE) is a virtual multicast network that provides point to point tunnels to connect multicast-enabled islands in the unicast ubiquitous Internet. Each island has one or more multicast routers that act as the Mbone tunnel end points. As a result, multicast content is encapsulated in unicast packets and transferred between multicast routers through the Internet. But, Mbone is still based on IP multicasting and cannot prevent the problems associated with IP multicasting.

Meta-Content multicasting introduces a Meta-Content concept and uses User Datagram Protocol (UDP) instead of HyperText Transport Protocol/Transmission Control Protocol (HTTP/TCP) for Internet content multicast. Meta-content is a series of mathematical metaphors that represent the original content according to a special algorithm. For a piece of content, a specific server generates a redundant stream of meta-content, and multicasts via UDP to specific clients. A client starts collecting pieces of meta-content until it can restore the content. Its benefit is that UDP is used to replace TCP for fast content transport and maximal bandwidth utilization. But, this requires IP multicasting support and can only work with proprietary software systems.

Hop-by-hop (HBH) multicasting introduces down-stream network hops as members in a multicast group. HBH uses multicast control tables for group membership information and multicast forward tables for content forwarding to reach all group members. HBH has smaller multicast routing tables and requires EP multicast support only on those routers close to the end users. But HBH still uses IP multicasting, and HBH-enabled routers must be deployed throughout the Internet to make this solution work.

End system multicasting, such as that described as the Carnegie Mellon University (CMU) Narada protocol, is an approach to realize application multicasting that moves the IP multicast functions from the network routers to end systems. That is, each member in a multicast group is a virtual “multicast router” that maintains a neighbor graph and replicates packets to its neighbors. End system multicasting does not need any multicast support from the network. However, it makes an end system more complicated, since it requires the end system to perform multicast routing while it receives the content. Additionally, a new member cannot join a multicast group unless it knows at least a live “end system” in its neighborhood.

A known solution that has been attempted is to cache streaming media in advance at a locations close to end networks, so that transmission of streaming media doesn't need to travel as far over most of the communication network. There are two disadvantages to this. First, content caching network devices require large memories to be utilized to store the content throughout the network. Additionally, due to the large storage requirements, storage servers rather than the network devices 28 are generally used to cache all of the available media streams that may potentially be requested by the end users. Hence, media caching is unlikely to alleviate congestion on the link 26 since the content servers are likely to be placed closer to the edge of the backbone network. Moreover, for live streaming media (streaming media that is being created contemporaneously with transmission) caching servers are ineffective since the content does not exist beforehand and, hence, cannot be pre-cached.

In addition to the potential lack of capacity on link bandwidth, requiring the streaming media server 10 to host a large number of SMS sessions may cause network congestion and service interruption on the streaming media server(s) 10. One way to ameliorate this is to use server load balancing. Server load balancing is well known in Internet web access. Recent network switch products such as web switches can balance the server load in a service provider network by shifting client requests from one server to another. Server load balancing can prevent a server from overloading when other servers are underloaded. However, server load balancing neither reduces the number of client connections nor increases the server capacity. Once the total capacity of the media servers reaches a particular limit, service interruption problems reoccur.

Recent proposals have been proposed to enable streaming media to be replicated on the network. A major proposal is to add a streaming media proxy on network devices to redirect client requests to inline streaming media proxy services or offline streaming media proxy server. A typical solution of this proposal is to combine the proxy mechanism with caching servers. Another proposal uses traffic interception on network devices to detect client requests of particular streaming media services. While this proposal does not use a proxy, it also has not yet been developed into a feasible solution.

Accordingly, it would be advantageous to provide an apparatus configured to enable live streaming media to be transmitted to multiple end users while alleviating bandwidth requirements required to accommodate these transmissions.

### SUMMARY OF THE INVENTION

The present invention overcomes these and other drawbacks by providing a method and apparatus for live streaming media replication in a communication network. Embodiments of the invention may reduce bandwidth requirements on the network and/or reduce the number of SMS sessions required to be hosted by the streaming media server, although the invention is not limited to a solution that achieves either or both of these potential benefits. According to one embodiment of the invention, streaming media requests are intercepted by a network element on the network. A network service, referred to herein as a “replication service,” evaluates the request and, if the streaming media is not currently streaming through the network element, interfaces with the streaming media server to fulfill the request. If the streaming media is already streaming through the network element, the network element replicates the streaming media and forwards the streaming media to the requesting user.

The replication service is deployed on a network element such as a router and provides a number of function modules, such as client/service registration, classification, packet interception and forwarding, media replication, status monitoring, and configuration management. The modules of the replication service interact together to form a service that may allow streaming media to be replicated intermediate the streaming media service provider and end users. The replication service is transparent to the end users so that they can act normally without any change.

By replicating the streaming media for the user rather than establishing a new SMS session from the streaming media server, it is possible to reduce bandwidth on the links connecting the streaming media server with the replication network element, and hence reduce the costs associated with providing those services. Additionally, by enabling replication to happen in the network, the streaming media server may serve more end users without being required to host an individual SMS session for each end user. This reduces the likelihood that the streaming media server will encounter an overload condition and reduces the amount of bandwidth required to connect the streaming media server to the backbone network. Moreover, by utilizing a network service on the network element to handle packet replication and employing prevailing unicast protocols to handle packet distribution, it is possible to replicate packets for distribution to mulitiple users without requiring all network devices in the path between the streaming media server and the end user(s) to agree on, implement, and support a multicast protocol.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIG. 1 is a functional block diagram of an example of a conventional network architecture incorporating a streaming media server;

FIG. 2 is a functional block diagram of a network illustrating streaming media from a streaming media server to end users according to conventional methods;

FIGS. 3-5 are functional block diagrams of networks illustrating methods of using replication software to facilitate distribution of streaming media from a streaming media server to end users according to embodiments of the invention;

FIG. 6 is a functional block diagram of a network illustrating a method of using the replication service at the ingress to the network adjacent the streaming media server as well as at the egress from the network adjacent the end users according to an embodiment of the invention;

FIG. 7 is a flow chart illustrating an example of acts that may be performed by the replication service according to an embodiment of the invention;

FIG. 8 is an example of a software package for deployment on a network element including replication software according to an embodiment of the invention; and

FIG. 9 is a functional block diagram of a network element configured to implement streaming media replication according to an embodiment of the invention.

### DETAILED DESCRIPTION

The following detailed description sets forth numerous specific details to provide a thorough understanding of the invention. However, those skilled in the art will appreciate that the invention may be practiced without these specific details. In other instances, well-known methods, procedures, components, protocols, algorithms, and circuits have not been described in detail so as not to obscure the invention.

According to embodiments of the invention, streaming media may be replicated at selective points in a communication network to enable bandwidth on other sections of the network to be reduced and reduce the burden on the streaming media server. According to one embodiment of the invention, streaming media requests are intercepted by a network element at a selected point. A network service, referred to herein as a Replication Service, evaluates the request and, if the streaming media is not currently streaming through the network element, interfaces with a streaming media server to obtain the streaming media. If the streaming media is already streaming through the network element, the network element replicates the streaming media and forwards the streaming media to the requesting user. By replicating the streaming media for the user rather than establishing a new SMS session from the streaming media server, it is possible to reduce bandwidth on the links connecting the streaming media server with the selected replication point. Additionally, by enabling replication to happen in the network, the streaming media server may serve more end users without being required to host an individual SMS session for each end user. This reduces the likelihood that the streaming media server will encounter an overload condition and reduces the amount of bandwidth required to connect the streaming media server to the backbone network. Moreover, By utilizing the replication service to handle packet replication and prevailing network unicast protocols to handle packet distribution, it is possible to replicate packets for distribution to multiple users without requiring all network devices in the path between the streaming media server and the end user(s) to agree on, implement, and support a multicast protocol.

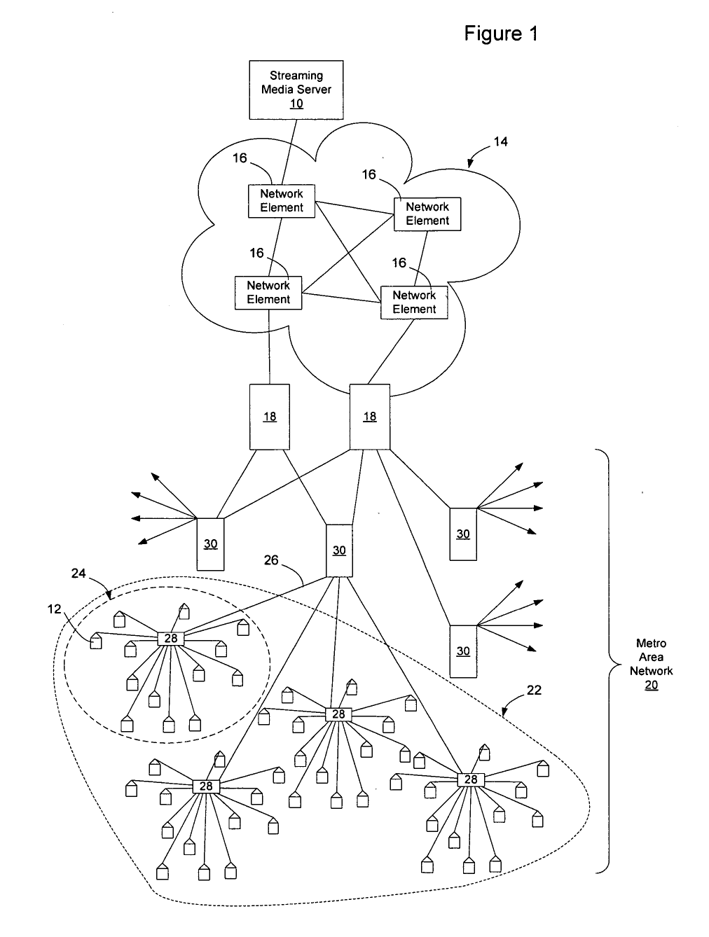

FIGS. 3-5 illustrate examples of how the replication service according to an embodiment of the invention may be deployed on a network, such as the network illustrated in FIG. 1. In the examples shown in FIGS. 3-5, only two layers of network elements, end network elements 28 and edge network elements 30, have been illustrated as implementing the replication service according to embodiments of the invention. The invention is not limited to these illustrated examples, as the replication service may be implemented on other network devices at other places in the network as well. Accordingly, the invention is not limited to deployment only in the illustrated locations in FIGS. 3-5, as these locations have been selected merely to illustrate potential uses of the invention on an example network.

As shown in FIG. 3, a replication service 32 may be integrated with or connected to an end network element 28 serving end users 12. In this embodiment, the replication service is configured to intercept requests for access to streaming media and interface those requests to the streaming media server 10 as necessary. The replication service 32 may be deployed in the network in individual end network elements 28, may be housed in a separate network element (32′) and attached to the end network element 28, or may be a shared network resource 32″. The invention is not limited to how the replication service is deployed or made available to network elements 28. In one embodiment, the end network elements 28 are routers, which can be IP routers and as recommended layer 4-7 content switches, configured to perform a variety of network services, such as routing services, and security/firewall services, and the replication service is another network service provided by the router. The invention is not limited to implementation on a router, however. In this embodiment, a router may be any network element that is configured to intercept, filter, or mirror, and forward packets on the network.

Optionally, where the end network is a passive optical network and the backbone is also an optical network, the network element 28 or (30 at an edge network) may be a demarcation point between two optical networks. The invention is thus not limited to a particular type of network and may be utilized in connection with many different types of networks and network devices. For example, the replication service may be included in a layer 3 network device such as a router, a layer 2 network device such as a switch, a layer 4 plus network device such as a content switch, a wireless access point, a Digital Subscriber Line Access Multiplexer (DSLAM), an access gateway, or any other type of network device. The replication service may be used on a public network such as the Internet, a private network such as a Local Area Network (LAN) or in any other type of communication network.

The replication service, at a functional level, operates to interconnect end users with a streaming media server to enable streaming media to be streamed to multiple end users without requiring the underlying network to be compliant with a multicast protocol. It also allows a streaming media server to serve multiple requests without generating an individual media stream for each request, thus enabling it to serve larger numbers of end users without encountering congestion.

As discussed in greater detail below, according to one embodiment of the invention, the replication service is a network service that is deployed on a network element and configured to receive requests for streaming media from end users and fulfill those requests by either requesting the streaming media from the streaming media server or causing the request to be fulfilled by replicating a streaming media service to the end user. Allowing a request for streaming media service to be fulfilled without generating a new SMS session reduces the number of sessions that must be provided simultaneously by the streaming media server, and reduces the bandwidth on the link upstream from the replication service, thus lowering the cost associated with providing the streaming media services to the requesting end users.

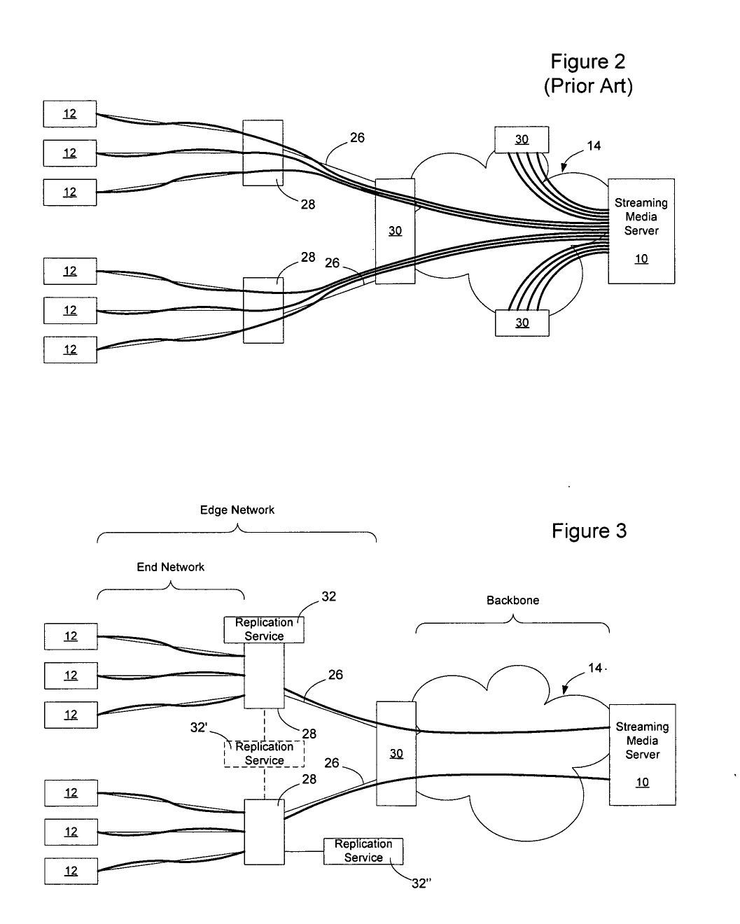

A comparison between FIGS. 2 and 3 illustrates the bandwidth conservation on the network. Specifically, in FIG. 2, six end users 12 are being supplied with streaming media from a streaming media server. For the sake of this example, it will be assumed that all of the streaming media content is the same, such as live video coverage of a sports event. Accordingly, as shown in FIG. 2, each link 26 connecting network elements 28 and 30 is required to carry one SMS session for each end user that wishes to have access to the streaming media. By contrast, in the embodiment illustrated in FIG. 3, the replication service is able to reduce the bandwidth on its associated link 26 to one SMS session by replicating the streaming media services for its end users. This bandwidth requirement savings is manifest on the backbone network as well, although the backbone is assumed to have sufficient bandwidth to handle any amount of traffic generated by the streaming media server.

Using a replication service, instead of a multicast protocol, enables staged deployment to be implemented without requiring the underlying transport network to be upgraded. Specifically, according to embodiments of the invention, the replication service is a streaming media-savvy control mechanism deployed on a network element, such as network element 28 or network element 30, that functions to act as a transparent intermediary between the end user and the streaming media server. Standard unicast protocols may be used to stream the media from the streaming media server to the network element hosting the replication service, and between the network element hosting the replication service and the end users. Accordingly, an Internet Service Provider, providing service to end users 12 through network element 28, may deploy the replication service according to an embodiment of the invention independently, and without requiring the backbone or other network elements be upgraded to implement one of the relatively complex multicast protocols. By making the service transparent, the end users are not required to adopt a special software package or utilize a specific control mechanism to enable the replication service to be deployed on the network.

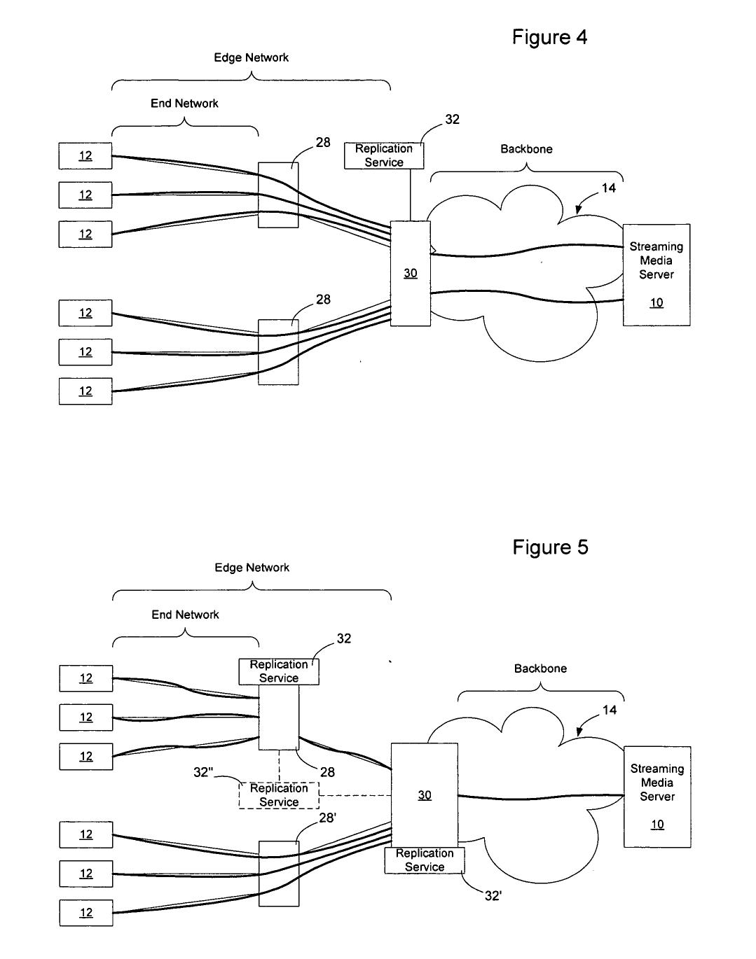

FIG. 4 illustrates another location where the replication service may be deployed in the network. In this embodiment, the replication service 32 is deployed at the edge network level in an edge network element 30. The replication service 32 may be incorporated into the edge network element 30 (not shown) or provided external to the edge network element and interfaced with the edge network element (as shown). The invention may be deployed in either fashion and the invention is not limited to any particular deployment implementation.

FIG. 5 illustrates another manner in which the replication service may be deployed in the network. In the embodiment illustrated in FIG. 5, the replication service may be selectively deployed throughout the network so that replication may take place at a higher-level network element for those lower-level network elements that are not capable of performing packet replication services. Specifically, as shown in FIG. 5, in this embodiment the end network element 28 has been provided or interfaced with the replication service. Accordingly, it is able to handle streaming media replication on behalf of the attached end users 12. The end network element 28′ is not capable of packet replication, has not been provided with or interfaced to the replication service, or is otherwise not configured to participate in the packet replication system described herein. However, the higher-level edge network element 30 has been provided with the replication service. Accordingly, the edge network element 30 may perform replication services on behalf of the end users 12 that connect through the end network device 28′. Optionally, the replication service at the higher level network element may treat the end network element 28 as a user, intercept streaming media requests from it, and further reduce the number of connections to the streaming media server 10. Thus, a layered replication services architecture may be implemented to further reduce the bandwidth on links interconnecting the network elements and the streaming media server.

As discussed in greater detail below, upon receipt of a streaming media request, the replication service 32 ascertains if the requested streaming media is already streaming through the network element 28. If the streaming media is already being handled by the network element 28, the replication service 32 causes the network element to replicate the streaming media and additionally transmit the streaming media to the new requesting end user. If the network element 28 is not handling the requested streaming media, the replication service allows the request to be passed to the streaming media server or generates a new request for streaming media and issues the request to the streaming media server 10. Subsequent requests for access to this new streaming media will be intercepted, as discussed above, and the streaming media may be made available to new requesting end users.

Many types of media may be transmitted from a streaming media server. Examples of conventional streaming media include audio programs such as music, audio-video productions such as movies, sporting events, news casts, games, and computer generated data streams. The invention is not limited to any particular type of streaming media.

The streaming media contemplated to be handled by the replication service, however, is not to be cached by the replication service and transmitted by the replication service at a later time. Rather, the replication service, according to embodiments of the invention, releases a piece of media received just after replication and transmission to the intended recipients. Accordingly, the replication service does not require large storage resources as a caching service does, and as that term is used contemporaneously. Additionally, the replication service is not a proxy as that term is used contemporaneously. Specifically, according to an embodiment of the invention, end users do not configure or even know with the replication service. The replication service rather is configured to intercept streaming media requests generated by end users and thereby appears transparent to the end users.

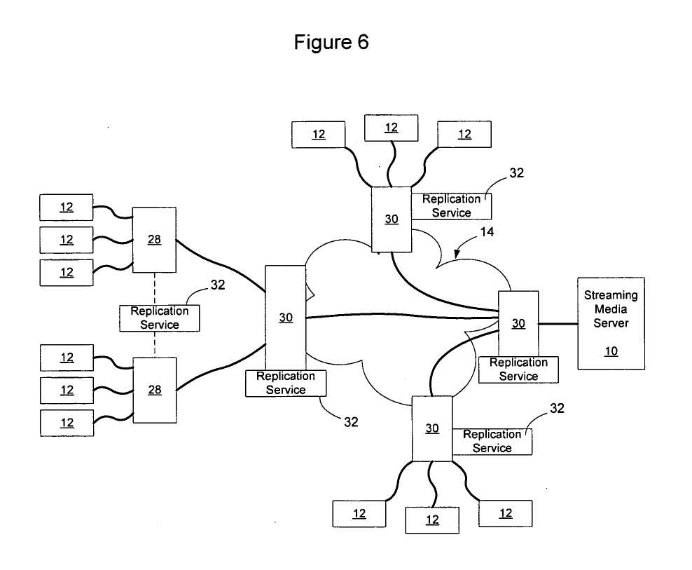

In the previous several embodiments, the invention has been described as operating at the egress to the network adjacent the end users 12. The invention is not limited in this manner as the replication service may similarly be utilized at the ingress to the network adjacent the media server. Using a replication service at the ingress may be particularly useful for entities such as small businesses, home users, and wireless users, desiring to stream media from farther away from the edge of the backbone network. While it may also be used for large streaming media providers, such as news sources and other big corporations, such streaming media sources typically may be situated sufficiently close to the ingress to the backbone to make replication on the ingress unnecessary. FIG. 6 illustrates one embodiment in which the replication service is deployed in a network element at the ingress to the network adjacent the media server. Deploying the replication service for ingress traffic enables the media server to be placed closer to the edge of the network and utilize lower bandwidth communication links to host streaming media sessions. This, accordingly, enables the streaming media service provider to reduce its costs by not requiring the streaming media service provider to have direct or near direct access to the communications backbone.

As shown in FIG. 6, the streaming media server 10 according to an embodiment of the invention is connected to the communications network 14 through an end network element 28 or an edge network element 30 containing or interfacing a replication service 32. Providing a replication service on one of the network elements connecting the streaming media server 10 to the communications network 14 enables the streaming media server 10 to host a single streaming media session for all end users regardless of where on the communication network they reside. This reduces the bandwidth requirements on the portion of the communication network between the replication service 32 and the streaming media server 10 to enable the streaming media server to be deployed closer to the edge of the network.

For example, as shown in FIG. 6, in this embodiment streaming media sessions from the streaming media server are intercepted by the replication service adjacent the ingress to the communication network and replicated at that point to be distributed to various edge and end networks connected to the communication network. These sessions may be further replicated at the edge or end network devices to provide streaming media services to end users 12. By using the replication service at several points in the network it is possible to minimize transmission requirements throughout the network and hence minimize costs associated with providing the streaming media services.

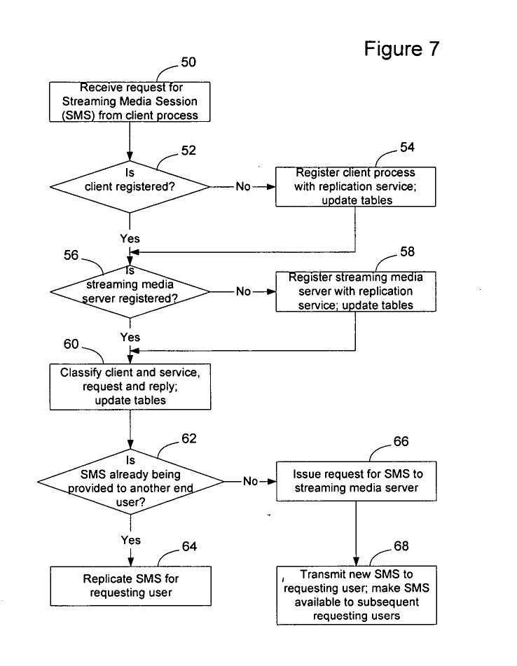

FIG. 7 is a flow chart illustrating the behavior of an example of a replication service according to an embodiment of the invention. As shown in FIG. 7, upon receipt of a request for access to a streaming media service (SMS) from a client process (50), the replication service determines if the client is registered with the registration service (52). Registration may be important for several reasons. For example, the registration service may need to have identification information associated with the client process to determine if the end user is able to authenticate its identity to the registration service, is authorized to receive streaming media services, and to establish accounting entries so that the client can be charged for the provision of streaming media services. The client registration may be used for other pragmatic considerations as well, such as to exchange encryption keys, transmission parameters, and other items of information that may be useful for the parties to enable the streaming media to be transferred in a useable and/or secure format. According to one embodiment of the invention, registration may be performed automatically when the client sends a request to the streaming media server for access to particular streaming media services. Those clients, according to an embodiment of the invention, may not be aware of the replication service or that its request is not being handled directly by the streaming media server. Normally, for a streaming media service, there is no direct communication between a client and the replication service, i.e., the client in normal operation would not specifically direct communication toward the replication service but would instead direct communication toward the streaming media server. However, if a client has special privilege to the replication service or uses a particular feature of the replication service, it may need to communicate with the replication service.

If the client process is not registered with the replication service, the replication service will obtain the client identity from the request and look up the client information from the service database that is set up initially in connection with service configuration. Then the replication service registers the client process by adding appropriate entries in the registration process update tables. (54). A premium client usually has its service profile pre-established with a service provider. Other processes may take place in connection with registration and the invention is not limited to these several examples.

If the client process is registered or after the client process has been registered, the replication service checks to see if the streaming media server is registered with the replication service (56). Registration of the streaming media service may encompass logging of identity information, location/address information, or other information relevant to access to the streaming media server. Additionally, the media streamed to the end user, in many cases, will be subject to copyright protection. In these instances, since the replication service is replicating the data stream, the replication service will need to pay royalties to the copyright owner for copying the streaming media on behalf of the clients it serves or tell the streaming media provider (inline or offline by its client/service and status monitoring modules) which end users requested the content so that the end users may be billed for the content. The replication service has an extensible interface for billing clients according to their requested services. Registration of the streaming media service with the replication service, and vice versa, enables appropriate accounting and auditing to take place between the participants in the streaming media replication process to enable the appropriate accounting to be done to the copyright owner. If the streaming media service is not registered with the replication service, the replication service will register with the streaming media server (58). Optionally, all of the registration processes may be performed concurrently, for example by making the registration of the streaming media service part of the client registration process discussed above, or the service registration process discussed below.

Once the client and the requested streaming media service (SMS) are all registered and the replication service thus obtains appropriate information to enable streaming media to be delivered to the end user, the client request is classified to ascertain what SMS is being requested by the client (60). Classification enables the replication service to obtain information that it will use to ascertain if it is currently handling the requested streaming media for another end user, or to enter into a table so that it will be able to identify the streaming media at a later time if requested by another end user. Simulating an SMS server, the replication service may also reply to the client about the status of its request at this or at any other time during the process. Classification may involve processing registration information about the SMS description and about the client request specifications in order to identify an SMS desired by the end user. Using the same information or information derived from the classification or identification information for all the participants in one SMS may advantageously avoid inconsistencies in classification by the replication service and further simplify implementation of the replication service on the network element. Additionally, classification is useful to enable the replication service to identify content provided by the streaming media provider as part of the streaming media service.

Once the request is classified, the replication service ascertains whether it is currently handling the requested streaming media service for another end user (62). Optionally, requests may occur for access to streaming media in the future, and the replication service may use this scheduling information contained in the request to ascertain whether it has other requests for the same streaming media service at the future requested point.

If the replication service is handling the requested streaming media service for another end user, it will set the appropriate filters to capture packets from that SMS session, generate headers for the replicated packets, replicate the payload portion of the captured packets, and cause the captured and replicated packets to be output to the intended end users (64).

If the replication service is not handling the requested streaming media service for another end user, it will interface with the streaming media server by passing the request or issuing a new or modified request to the appropriate streaming media server to create a new SMS session to the end user (66). The packets in this SMS session will be passed to the end user (68). If, at a later time, the replication service receives a request for access to the streaming media service from other users, it may make the SMS session available to those users using the process outlined above.

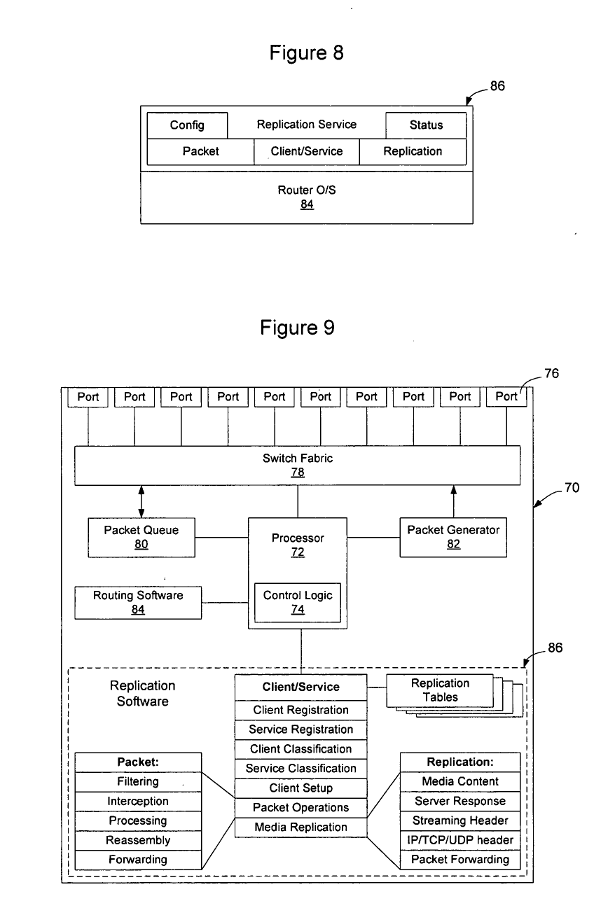

FIG. 8 illustrates one example of a replication service software environment interfaced with a routing software environment such as a router OS 84. The replication service may be physically collocated with the routing software, or mated with the routing software from a plug-in blade on a network element, or interfaced to the routing software from an attached network element, e.g., an external hardware component associated with the network element. The invention is not limited to disposition of a replication service software package that is configured to run on a network element.

As shown in FIG. 8, the replication service software environment has several subsystem. A first subsystem, referred to herein as a configuration module, provides a management interface to the replication service to enable the network operator to set parameters associated with provision of services on the network. Examples of aspects of service provision that may be set include setting the maximum number of different concurrent SMS sessions that may coexist at any one time through a given router, limiting the number of streaming media services that may be transmitted to a given end-user at any one time, setting a maximum transmission rate at which the network element will stream media in a SMS session, setting data sources such as client profiles, service classes or transmission priorities, and many other parameters. For example, the configuration module may interface with the management information base (MIB) to set values and read values associated with the performance of the replication service on the network element. The invention is not limited to particular configuration parameters configurable through this module on the replication service. Optionally, where the routing software interfaced by the replication service has a configuration module or configuration subsystem, the replication service may be accessed through the routing software by interfacing the routing software system with the configuration module of the replication service software system.

The replication service software module also includes a status subsystem configured to enable the status of the SMS sessions to be monitored prior to, during, and after the SMS sessions have been configured through the replication service. Information collected by the status subsystem may include information such as the identity of the SMS sessions handled by the registration service, the genre of the SMS sessions, which end users requested access to which streaming media service by identity or genera, the average duration of the SMS sessions, and many other aspects associated with the nature of the services provided by the replication service such as account billing.

Additionally, the status subsystem may be used to monitor the status of the SMS sessions handled by the network element. SMS sessions may not have a predefined end point. For example, a professional boxing match may last anywhere from a few seconds to over an hour. If the streaming media service is a coverage of the professional boxing match, it may not be possible to specify at the outset the duration of the streaming media service or SMS session. As a given network element may be only able to handle a set number of SMS sessions, the status subsystem may detect when SMS sessions have terminated so that the network element may be allowed to handle additional SMS sessions for its end users.

There are several ways of determining when an SMS session has ended. One way may be through the use of a control packet generated by the streaming media server indicating that the streaming media service or SMS session has ended. Another way may be to monitor traffic filtered out by the network element for replication or transmission to the end user(s). Another way may be to monitor acknowledgement traffic filtered out by the network element for requests from the end user. Where either of media or acknowledgement traffic is not received for a predetermined period of time, for example 30 seconds, it may be assumed that the SMS session has terminated.

The main software subsystem associated with the replication service is the client/service subsystem. The client/services subsystem controls two other subsystems (packet and replication) and manages streaming media services and clients, including client and service registrations and classifications, and client-service connections. The client/services subsystem also handles control messages generated in connection with providing replication services. One example control protocol that may be used to exchange control messages between the end users, replication service, and streaming media server, is the Real Time Control Protocol (RTCP) described in Internet Engineering Task Force (IETF) Request For Comments (RFC) number 3550, the content of which is hereby incorporated herein by reference. Another example is the streaming acknowledgement messages such as TCP and UDP feedbacks. Other control protocols may be used as well, and the invention is not limited to an embodiment utilizing one of these particular mentioned control protocols.

The client/service subsystem works in connection with two subservient subsystems, the packet subsystem and the replication subsystem, to provide the replication services on the communication network. The packet operations subsystem provides the packet processing capability over targeted streaming media traffic, including packet filtering, packet interception, packet processing, packet reassembly, and packet forwarding. This subsystem interfaces with the network element to set filter rules on the network element, intercept packets associated with the streaming media service, instruct the processor how to process the intercepted packets, set rules associated with reassembly of the packets, and provide rules associated with forwarding the packets on to the end users.

In the embodiment shown in FIG. 9, the packet subsystem has several modules to enable it to process network traffic. Specifically, in this embodiment, a filter module sets up or removes IP filters for traffic redirection of streaming media clients and servers (to a replication service), an interception module receives and intercepts the redirected traffic, a processing module processes the protocol headers of the intercepted packets from clients and servers, a reassemble module reassembles IP packets for client connections and media replication, and a forwarding module forwards the re-assembled packets to their destinations. The invention is not limited to an embodiment having these particular modules as other and additional modules may be utilized as well.

The media replication subsystem provides the streaming media content replications to multiple clients, including IP/TCP/UDP header replication, streaming protocol header replication, server response replication, and data content replication. In the embodiment shown in FIG. 9, the replication module has several modules to enable it to provide content replication to its clients. Specifically, in this embodiment a media content module replicates the media content of an SMS to a client, a server response module handles interactions with the streaming media server, a streaming header module generates the streaming protocol header such as RealTime Streaming Protocol (RTSP) and Realtime Transport Protocol (RTP) of a media content replication, an IP/TCP/UDP header module generates the IP protocol header of a media content replication, and a packet forwarding module uses the packet module to send the replication packets to the network.

When an edge device starts, the replication service sets up traffic filters such as IP (L3+) filters on the devices to intercept the network traffic of preset streaming media services. When a client tries to connect to a streaming media service, the edge device intercepts the connection request and redirects the request to the packet module. The client connection request is processed so that the replication service, through the client/service module, learns whether this client is a new client and whether the requested service is a new service. If the client is new, the replication service registers this client with the requested service. If the service is new, the replication service creates a media connection to the media server. When the server connection feedback is redirected, the replication service registers this service and starts the client connections according to the server feedback. When a service sends out media, the replication service intercepts the media traffic by the packet module and uses the replication module to replicate the media content for each client that request the service. Then, the replication service also uses the packet module to forward the media replication to the client destinations.

For later clients requesting an existing service, the replication service does not create a new connection to the media server. Rather, the replication service uses the server connection feedback to establish a new client connection. Once the connection is done, the replication service replicates the oncoming media content to the client in real time. The replication service, in this context, is configured to replicate relatively contemporaneous portions of streaming media since the replication service is not configured to cache media for later reproduction and distribution.

In the replication service, streaming media clients and servers are classified by their respective information, for example source IP address, transport protocols and port numbers, and service names and program IDs. Thus, a client and a server can be identified uniquely from the streaming protocol used. This creates an opportunity for an ISP to use the classification capability to apply particular service enhancements, such as client authentication, service priorities, and billing. The replication service is a configurable service so that an ISP can configure the replication service for its own purposes. To this end, as discussed above, the replication service is provided with auxiliary modules, such as a configuration module for service setup, control, and customization, and a status module for service monitoring, reporting, and statistics generation.

FIG. 9 illustrates a network element configured to perform replication services according to an embodiment of the invention. As shown in FIG. 9, the network element 70 contains a processor 72 having control logic 74 configured to implement the functions associated with the replication services as described above in connection with FIGS. 1-7.

Most network elements have two hardware planes—a transport plane that forwards data from one port to another, and a control plane that controls how data is forwarded. The replication service, according to an embodiment of the invention, resides in or interfaces with the control plane to apply intelligent control over streaming media traffic and over the replication of media content to multiple clients. In the event that an edge device has limited capacity in its control plane, it can attach additional hardware such as a competent computing blade or a replication service-specific accelerator. In the embodiment illustrated in FIG. 9, the replication software may therefore be resident in the network element 70 or may be associated with the network element 70 but physically instantiated on a separate computing platform/environment such as in a computing environment on a blade server. The invention is not limited to a particular implementation or particular manner of instantiating the replication service software.

In the embodiment illustrated in FIG. 9, the network element 70 includes interfaces (ports) 76 configured to interface with links on the communication network. A subset of the ports in the network element are configured to face toward network users to handle communications with the network users and, optionally, one or more ports may be configured to face the backbone network or other higher bandwidth network communication service.

The ports 76 are connected to a switch fabric 78 which routes traffic between ports under the control of the processor 72 running control logic 74. A packet queue 80 may be provided to temporarily store packets as routing/switching decisions are being made as to how the packets should be handled by the switch fabric. A packet generator 82, under the control of the network processor, is provided to inject replicated packets into the switch fabric to enable the network element to transmit packets to the intended recipients of a streaming media service. The switch fabric and network element operations are directed by routing software 84, which may include an associated routing information base and other standard network element software modules or subsystems.

According to an embodiment of the invention, a the network element also includes or is interfaced to a replication software subsystem 86 containing data and instructions to enable the network processor to cause the network element to perform the functions ascribed to the replication service described above.

The control logic of FIG. 9 may be implemented as a set of program instructions that are stored in computer readable memory within the network element and executed on a microprocessor within the network element. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, or any other device including any combination thereof. Programmable logic can be fixed temporarily or permanently in a tangible medium such as a read-only memory chip, a computer memory, a disk, or other storage medium. Programmable logic can also be fixed in a computer data signal embodied in a carrier wave, allowing the programmable logic to be transmitted over an interface such as a computer bus or communication network. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

1. A method for live streaming media replication in a communication network, the method comprising the steps of:
intercepting a request by a client for access to a streaming media service available from a streaming media provider, by a replication service on a network element intermediate the client and a streaming media provider;
registering the client if the client is not already registered with the replication service;
registering the requested streaming media service if it is not already registered with the replication service;
establishing a unique streaming media session with the streaming media provider if the streaming media service is not currently being handled by the replication service;
configuring the replication service to intercept protocol data units associated with the streaming media service;
replicating the streaming media from the established streaming media session to the client, after the streaming media session is established; and
monitoring the status of streaming media sessions for security and accounting purposes.

2. The method of claim 1, further comprising classifying the request by the intermediate network element to obtain a classified request.

3. The method of claim 1, further comprising determining whether the streaming media session is being handled by the replication service.

4. The method of claim 2, further comprising determining whether the streaming media session is being handled by the replication service by comparing the classified request against information associated with streaming media sessions being handled by the replication service.

5. The method of claim 1, further comprising scheduling delivery of the live streaming media session at a future point in time, and upon occurrence of the future point in time, performing the steps of obtaining and replicating.

6. The method of claim 1, further comprising registering the replication service with the streaming media service.

7. The method of claim 1, further comprising establishing accounting entities associated with the streaming media service.

8. The method of claim 1, wherein the step of configuring the replication service to intercept protocol data units comprises establishing filters to intercept traffic in the streaming media service.

9. The method of claim 1, further comprising the step of interfacing with the streaming media server to instruct the streaming media server to provide the requested streaming media.

10. The method of claim 1, wherein the step of intercepting, establishing, and replicating are transparent to the client.

11. The method of claim 1, wherein the request by the client for access to the streaming media session is generated by the client and addressed to the streaming media server.

12. An apparatus for implementing live streaming media replication in a communication network, comprising:
control logic configured to:
intercept requests for access to a streaming media service;
interface the intercepted request to the streaming media server if a streaming media session containing the streaming media service is not being handled by the apparatus;
replicate the streaming media session to provide the streaming media service if the requested streaming media session is being handled by the apparatus.

13. The apparatus of claim 12, wherein the control logic is further configured to classify the requests and use the classified requests to ascertain if the requested streaming media sessions are being handled by the apparatus.

14. The apparatus of claim 12, further comprising replication tables containing information relating to streaming media clients and streaming media sessions.

15. Replication software contained in a computer readable storage medium, comprising:
program code configured to perform client services;
program code configured to perform packet operations; and
program code configured to perform streaming media replication.

16. The replication software of claim 15, wherein the program code configured to perform client services is configured to perform streaming media client registration and streaming media client classification.

17. The replication software of claim 15, wherein the program code configured to perform client services is configured to perform streaming media service registration and streaming media service classification.

18. The replication software of claim 15, wherein the program code configured to perform packet operations is configured to implement packet filtering and packet interception to filter and intercept packets in a streaming media service.

19. The replication software of claim 18, wherein the program code configured to perform packet operations is further configured to implement packet processing, packet reassembly, and packet forwarding, for the packets filtered and intercepted from the streaming media service.

20. The replication software of claim 18, wherein the program code configured to perform media replication is configured to header replication on packets in a streaming media service.

21. The replication software of claim 18, wherein the program code configured to perform header replication is configured to perform at least one of Internet Protocol (IP) header information replication, Transmission Control Protocol (TCP) header information replication, and User Datagram Protocol (UDP) header information replication.

22. The replication software of claim 21, further comprising program code configured to perform streaming protocol header replication.
